(19) United States
(12) Patent Application Publication
(10) Pub. No.: US 2026/0267274 A1
(43) Pub. Date: Sep. 10, 2026

(54) SHEET STACKER AND IMAGE FORMING SYSTEM INCORPORATING SAME

(71) Applicants: Atsushi SHINODA, Kanagawa (JP); Sho ASANO, Kanagawa (JP); Yuusuke SHIBASAKI, Tokyo (JP); Wataru TAKAHASHI, Tokyo (JP); Tomomichi HOSHINO, Kanagawa (JP); Shota YOSHIDA, Kanagawa (JP); Kotomi KAMEYAMA, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(72) Inventors: Atsushi SHINODA, Kanagawa (JP); Sho ASANO, Kanagawa (JP); Yuusuke SHIBASAKI, Tokyo (JP); Wataru TAKAHASHI, Tokyo (JP); Tomomichi HOSHINO, Kanagawa (JP); Shota YOSHIDA, Kanagawa (JP); Kotomi KAMEYAMA, Kanagawa (JP); Shuuto TOHKAISHI, Kanagawa (JP); Hirotaka YASUKAWA, Kanagawa (JP); Shingo YOSHIZAWA, Kanagawa (JP); Naofumi YOSHIDA, Kanagawa (JP); Ryota TAKAYAMA, Kanagawa (JP); Akira KUNIEDA, Tokyo (JP); Jun YAMADA, Kanagawa (JP); Yuji SUZUKI, Kanagawa (JP); Wataru NOZAKI, Kanagawa (JP); Satoshi HIRATA, Saitama (JP); Takuya OKAMOTO, Tokyo (JP)

(73) Assignee: ETRIA CO., LTD., Yokohama-shi (JP)

(21) Appl. No.: 19/553,827

(22) Filed: Mar. 2, 2026

(30) Foreign Application Priority Data
Mar. 7, 2025 (JP) 2025-035951

(51) Int. Cl. G03G 15/00

(52) U.S. Cl. CPC G03G 15/6552; G03G 15/6582; G03G 2215/00556; G03G 2215/00877

(57) ABSTRACT

A sheet stacker including a bottom, a first-end side portion, and a second-end side portion. The bottom face is a face on which a sheet, subjected to a folding operation and ejected from an ejection portion in a sheet ejection direction, is stacked. The first-end side portion has a sliding face that is raised upward from the bottom face at a first end of the bottom face in a width direction orthogonal to the sheet ejection direction. The second-end side portion is raised upward from the bottom face at a second end opposite to the first end in the width direction. The sliding face of the first-end side portion is inclined or curved with respect to a vertical plane.

### CROSS-REFERENCE TO RELATED APPLICATION

This patent application is based on and claims priority pursuant to 35 U.S.C. § 119(a) to Japanese Patent Application No. 2025-035951, filed on Mar. 7, 2025, in the Japan Patent Office, the entire disclosure of which is hereby incorporated by reference herein.

### BACKGROUND

### Technical Field

Embodiments of the present disclosure relate to a sheet stacker that can stack sheets and an image forming system including the sheet stacker.

### Related Art

Various types of image forming systems including an image forming apparatus such as copier and printer are known that include a sheet stacker that receives sheets on each of which has an image and stacks the sheets.

On the other hand, in order to stack the sheet ejected from a sheet ejection member in a good manner, a sheet stacker in the art discloses a technique in which a protrusion is provided on the upper part of guides disposed on both sides in the width direction of the sheet, and the sheet ejected from the sheet ejection member is brought into contact with the protrusion and is bent downward in a convex shape.

In such a sheet stacker in the art, when a sheet ejected from an ejection portion freely falls onto a bottom to be stacked on the bottom, the sheet fails to maintain a substantially horizontal posture during the free fall and rotates, resulting in a stacking failure. In particular, in a sheet stacker in the art in which a sheet subjected to a folding operation is ejected and stacked, such a problem cannot be ignored.

Even when the technology of a sheet stacker in the art is applied and projections are provided on the side portions that are raised upward at both ends in the width direction, such a problem cannot be sufficiently solved.

### SUMMARY

Embodiments of the present disclosure described herein provide a novel sheet stacker including a bottom face, a first-end side portion, and a second-end side portion. The bottom face is a face on which a sheet, subjected to a folding operation and ejected from an ejection portion in a sheet ejection direction, is stacked. The first-end side portion has a sliding face that is raised upward from the bottom face at a first end of the bottom face in a width direction orthogonal to the sheet ejection direction. The second-end side portion is raised upward from the bottom face at a second end opposite to the first end in the width direction. The sliding face of the first-end side portion is inclined or curved with respect to a vertical plane.

Further, embodiments of the present disclosure described herein provide an image forming system including the above-described sheet stacker, an image forming apparatus, and a post-processing apparatus. The image forming apparatus is disposed upstream from the sheet stacker in a sheet conveyance direction, to form an image on a sheet. The post-processing apparatus performs the folding operation on the sheet with the image formed by the image forming apparatus, and conveys the sheet subjected to the folding operation to the sheet stacker.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to an embodiment of the present disclosure;

FIG. 2 is a block diagram illustrating a control system of an image forming system;

FIG. 3 is a main part of a sheet folder;

FIGS. 4A, 4B and 4C are diagrams each illustrating a sheet after a sheet folding operation;

FIGS. 5A, 5B, 5C, 5D, 5E, 5F, 5G and 5H are diagrams illustrating a series of operations of Z-folding operation in a sheet folder;

FIGS. 6A, 6B, 6C, 6D, 6E, 6F, 6G and 6H are diagrams illustrating a series of operations of letter fold-in operation in a sheet folder;

FIGS. 7A, 7B, 7C, 7D, 7E, 7F, 7G and 7H are diagrams illustrating a series of operations of letter fold-out operation in a sheet folder;

FIGS. 8A and 8B are diagrams illustrating a sheet stacker;

FIGS. 9A and 9B are diagrams illustrating a state where sheets subjected to a sheet folding operation freely fall in a sheet stacker;

FIG. 10 is a perspective view of a state where a sheet subjected to a sheet folding operation freely falls in a sheet stacking portion;

FIGS. 11A and 11B are diagrams illustrating a state where sheets subjected to a sheet folding operation freely fall in a sheet stacker, as a comparative example;

FIGS. 12A and 12B are diagrams illustrating a sheet stacker according to Modification 1 of the embodiments of the present disclosure;

FIGS. 13A and 13B are diagrams illustrating a sheet stacker according to Modification 2 of the embodiments of the present disclosure;

FIGS. 14A-1, 14A-2, 14B-1, 14B-2, 14C-1 and 14C-2 are diagrams illustrating a state where a sheet subjected to a sheet folding operation freely falls in a sheet stacker according to Modification 3 of the embodiments of the present disclosure;

FIGS. 15A and 15B are perspective views of a main part of a sheet stacker according to Modification 4 of the embodiments of the present disclosure;

FIGS. 16A-1 and 16A-2 are diagrams illustrating a state where a sheet freely falls in a sheet stacker according to Modification 4 of the embodiments of the present disclosure;

FIGS. 16B-1 and 16B-2 are diagrams illustrating a state where a sheet freely falls in a sheet stacker, as a comparative example;

FIG. 17 is a perspective view of a main part of a sheet stacker according to Modification 5 of the embodiments of the present disclosure;

FIGS. 18A and 18B are diagrams illustrating a sheet stacker according to Modification 6 of the embodiments of the present disclosure;

FIGS. 19A, 19B and 19C are diagrams illustrating a state where sheets subjected to a sheet folding operation freely fall in the sheet stacker of FIGS. 18A and 18B;

FIGS. 20A and 20B are diagrams illustrating a sheet stacker according to Modification 7 of the embodiments of the present disclosure;

FIGS. 21A and 21B are diagrams illustrating a sheet stacker according to Modification 8 of the embodiments of the present disclosure;

FIG. 22 is a perspective view of a main part of the sheet stacker of FIGS. 21A and 21B;

FIGS. 23A and 23B are diagrams illustrating a sheet stacker according to Modification 9 of the embodiments of the present disclosure;

FIG. 24 is a flowchart of a control process executed in the sheet stacker according to Modification 10 of the embodiments of the present disclosure;

FIGS. 25A and 25B are diagrams illustrating an example of a display on an operation display panel when the control of FIG. 24 is executed;

FIG. 26 is a drawing illustrating a main part of a sheet folder according to Modification 11;

FIG. 27 is a diagram illustrating a main part of a sheet folder according to Modification 12; and

FIG. 28 is a diagram illustrating an overall configuration of an image forming system according to Modification 13 of an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Like reference signs are assigned to identical or equivalent components and a description of those components may be simplified or omitted.

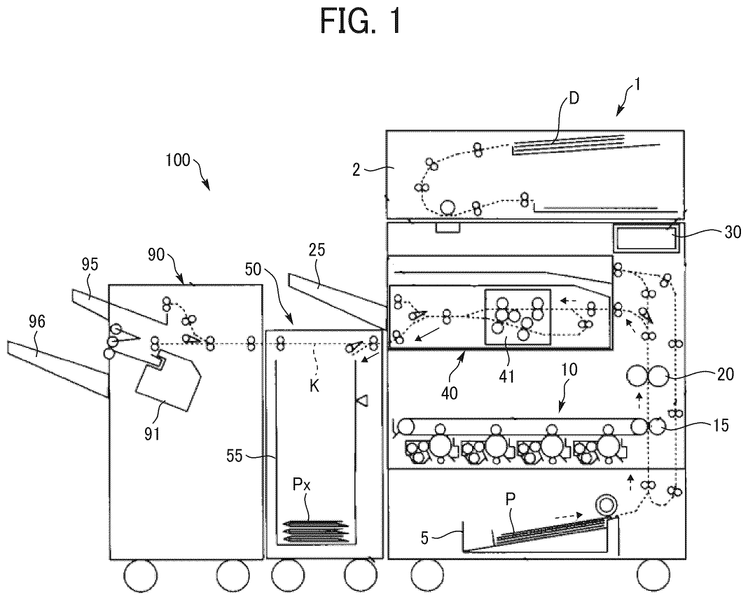

Initially with reference to FIG. 1, a description is given of the overall configuration of an image forming system 100 according to an embodiment of the present disclosure.

FIG. 1 is a diagram illustrating an overall configuration of an image forming system according to an embodiment of the present disclosure.

In the present embodiment, an image forming apparatus 1 includes a sheet folder 40 (as a first post-processing apparatus), a sheet stacker 50, and a sheet binder 90 (as a second post-processing apparatus). The sheet folder 40, the sheet stacker 50, and the sheet binder 90 are detachably attached to the image forming apparatus 1. The image forming apparatus 1, the sheet folder 40, the sheet stacker 50, and the sheet binder 90 are included in a single image forming system 100.

The sheet folder 40 as an inner finisher is an apparatus to perform a sheet folding operation on a sheet P subjected to image formation that is ejected from the image forming apparatus 1, and functions as a first post-processing apparatus. The sheet folder 40 according to the present embodiment is disposed in an in-body space of the image forming apparatus 1. The in-body space of the image forming apparatus 1 is located between an image forming device 10 and a document feeder and reader 2.

The sheet stacker 50 (compact folded sheet stacking apparatus) includes a sheet stacking portion 55, so that a sheet Px on which a sheet folding operation is performed by the sheet folder 40 is stackable (storable) in the sheet stacking portion 55. The sheet Px represents a sheet subjected to a process or operation, and referred to with reference letter “Px” to distinguish from an unprocessed sheet P.

In the present embodiment, even the sheet P that has not been folded by the sheet folder 40 is fed into the sheet stacker 50 and stacked (stored) in the sheet stacking portion 55 as long as the sheet P has a size that can be stored in the sheet stacking portion 55.

On the other hand, even though the sheet Px is folded by the sheet folder 40, in a case where the sheet Px exceeds a given size and is not storable in the sheet stacking portion 55, the sheet Px passes through a conveyance path K without being stored in the sheet stacking portion 55 and is conveyed toward the sheet binder 90, or is ejected to a first ejection tray 25 without being fed into the sheet stacker 50.

Similarly, the sheet P that has not been folded by the sheet folder 40 and that has a size not storable in the sheet stacking portion 55 is not stored in the sheet stacking portion 55, and passes through the conveyance path K and is conveyed toward the sheet binder 90, or is ejected to the first ejection tray 25 without being fed into the sheet stacker 50.

The sheet binder 90 (finisher) is an apparatus that performs a sheet binding operation (post-processing operation) on the sheet P after the image forming operation, which has passed through and fed to the sheet folder 40 and the sheet stacker 50, and functions as a second post-processing apparatus.

After the sheet P is fed to the sheet binder 90, the sheet binding processing device 91 of the sheet binder 90 performs the sheet binding operation on the sheet P and the sheet P is ejected to the third ejection tray 96, or the sheet P does not pass through the sheet binding processing device 91 to be ejected to the second ejection tray 95 as it is.

The post-processing operation and ejection destination on a sheet P subjected to image formation in the image forming system 100 described above can be specified by a user through an operation display panel 30 disposed on the exterior of the image forming apparatus 1.

A description is given of an example of the operations of the image forming system 100, specifically, the operations of the image forming system 100 from the operation in which the sheet folding operation is performed on the sheet P to the operation in which the sheet Px subjected to the sheet folding operation is stored on the sheet stacking portion 55 of the sheet stacker 50, with reference to FIG. 1.

Firstly, as a print job instruction based on the above-described conditions is issued by a user by the operation through the operation display panel 30, while an original document D set on a document table is conveyed in the document feeder and reader 2, the image information of the original document D is optically read. Then, based on the image information of the original document D, the images formed on multiple photoconductor drums in the image forming device 10 are transferred onto an intermediate transfer belt to form a color image.

Concurrently with such an image forming operation, the sheet P accommodated in a sheet tray 5 is conveyed toward the position of a secondary transfer roller 15 (secondary transfer nip region). Then, the image formed by the image forming device 10 is transferred onto the sheet P at the position of the secondary transfer roller 15.

After the above operation, the sheet P onto which the image is transferred at the position of the secondary transfer nip region is transferred to the position of a fixing device 20. At this position, the image transferred on the surface of the sheet P is fixed to the sheet P by application of heat by a fixing roller and pressure by a pressure roller. Then, the sheet P is ejected to the outside of the image forming apparatus 1 by a sheet ejection roller.

By so doing, a series of image forming processes (i.e., printing operation) of the image forming apparatus 1 is completed.

Subsequently, the sheet P subjected to image formation ejected from the image forming apparatus 1 is conveyed into the sheet folder 40 where the sheet folding operation is performed on the sheet P by a sheet folding processing device 41.

Then, the sheet Px subjected to the sheet folding operation is conveyed from the sheet folder 40 to the sheet stacker 50. Then, the sheet Px conveyed to the sheet stacker 50 free falls to be stacked onto the sheet stacking portion 55.

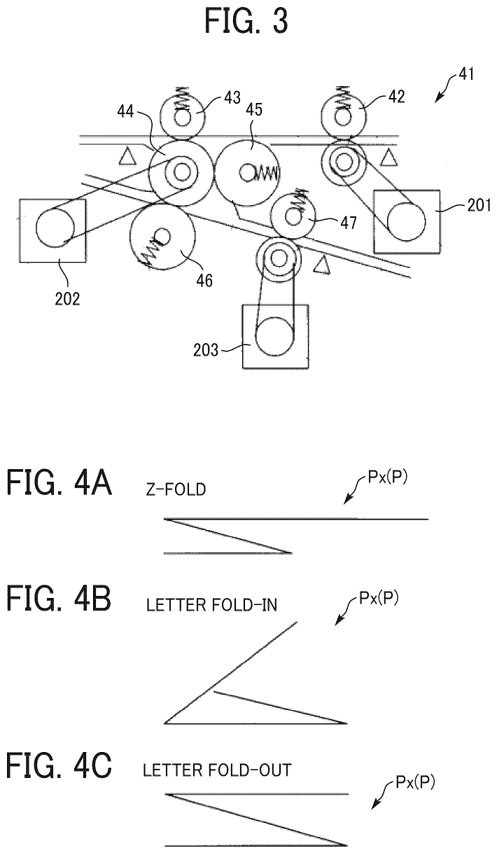

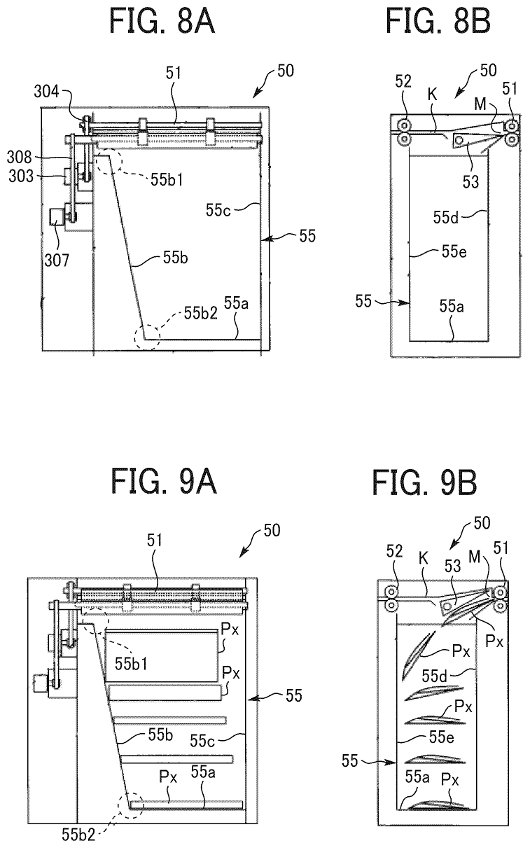

The configuration and operations of the sheet folding processing device 41 are described in detail below with reference to FIGS. 3 to 7H. Further, the configuration and operations of the sheet stacker 50 are described in detail below with reference to FIGS. 8A to 10.

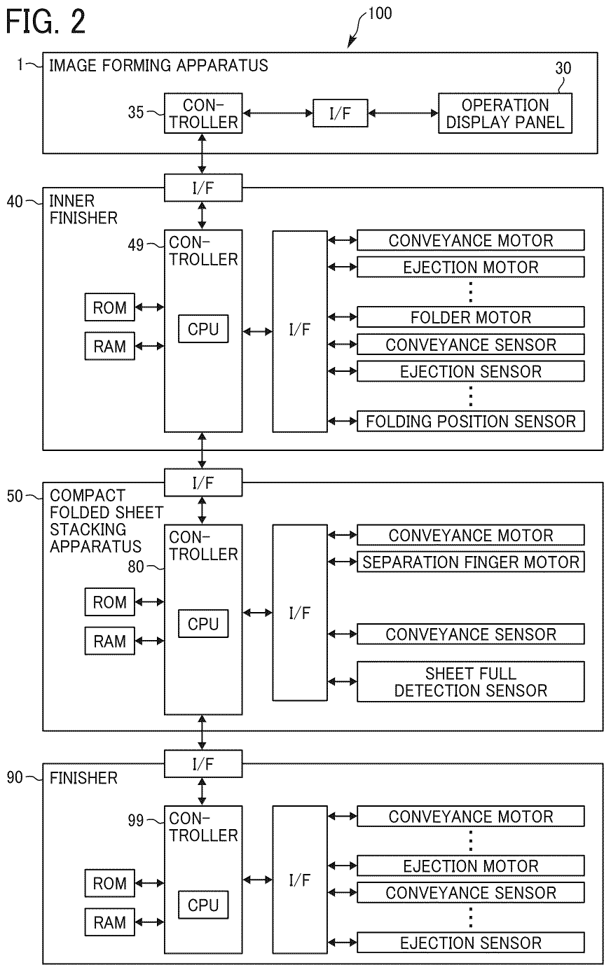

The image forming system 100 having such a configuration described above is controlled by a control system illustrated in FIG. 2 and is operated under the instruction by the control system.

The image forming apparatus 1, the sheet folder 40 (inner finisher), the sheet stacker 50 (compact folded sheet stacking apparatus), and the sheet binder 90 (finisher) included in the image forming system 100 are provided with respective controllers 35, 49, 80 and 99 that control the respective apparatuses. Further, the controllers 35, 49, 80 and 99 are each connected via an interface (I/F) to control targets such as motors and sensors. Further, the controllers 35, 49, 80 and 99 are connected to each other via an interface (I/F), allowing for control that spans across the apparatuses.

The overall control system of the image forming system 100 having the configuration described above executes various operations in the image forming system 100 described above with reference to FIG. 1.

A detailed description is given of the configuration and operations of the sheet folding processing device 41 of the sheet folder 40, with reference to FIG. 3 to 7H.

FIG. 3 is a main part of the sheet folder 40.

FIGS. 4A, 4B and 4C are diagrams each illustrating a sheet after a sheet folding operation.

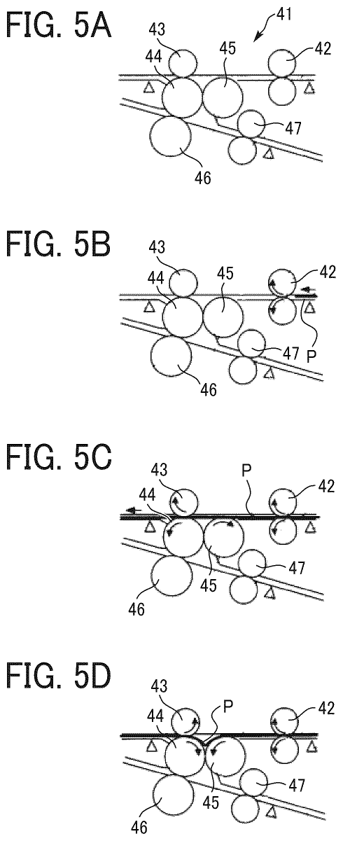

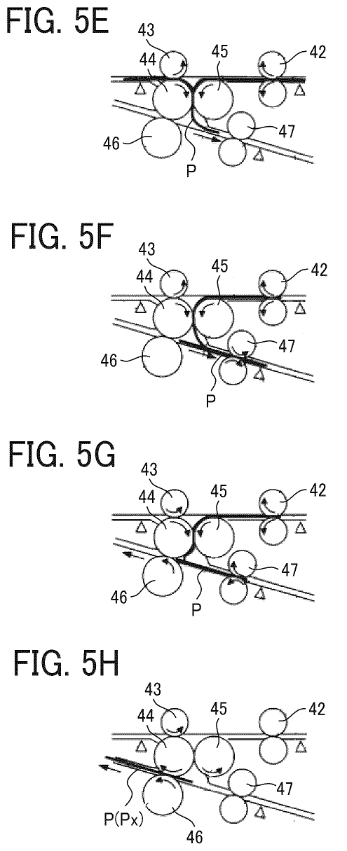

FIGS. 5A, 5B, 5C, 5D, 5E, 5F, 5G and 5H are diagrams illustrating a series of operations of Z-folding operation in the sheet folder 40.

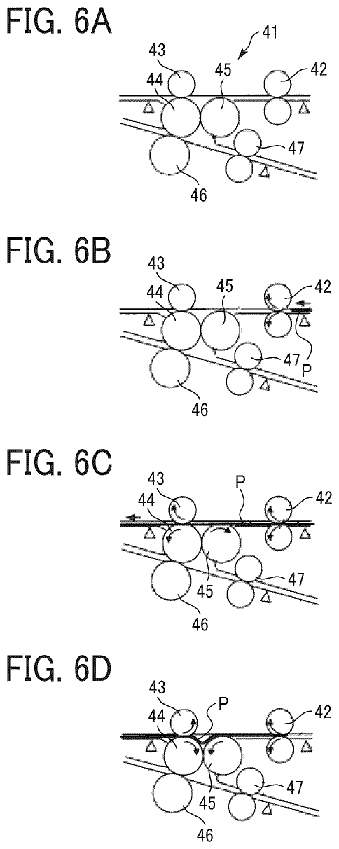

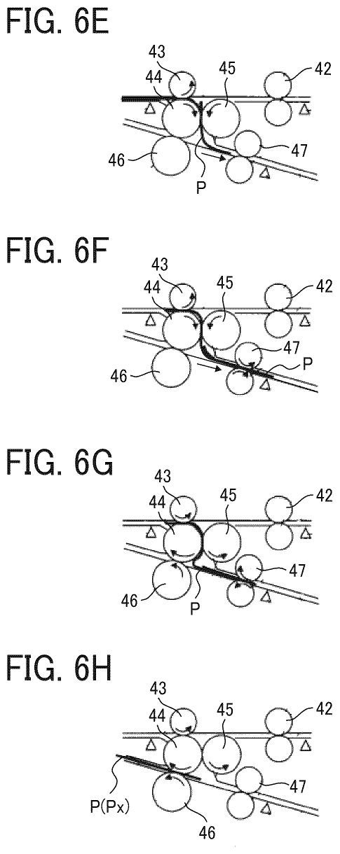

FIGS. 6A, 6B, 6C, 6D, 6E, 6F, 6G and 6H are diagrams illustrating a series of operations of letter fold-in operation in the sheet folder 40.

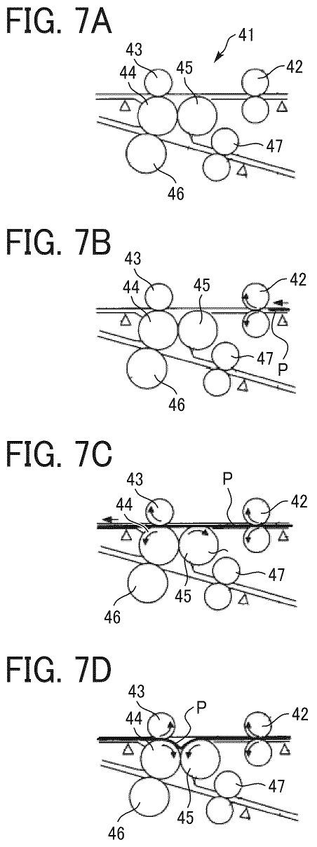

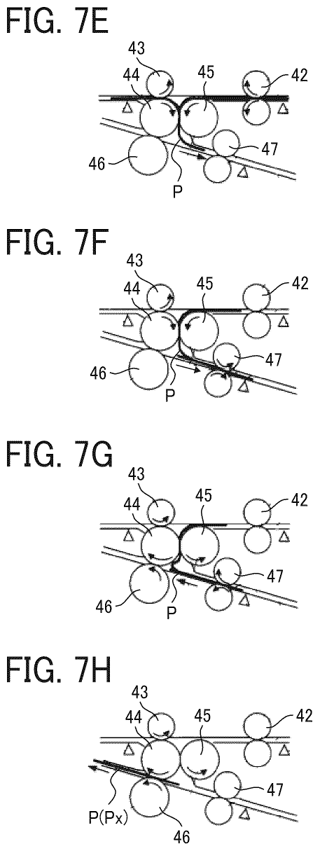

FIGS. 7A, 7B, 7C, 7D, 7E, 7F, 7G and 7H are diagrams illustrating a series of operations of letter fold-out operation in the sheet folder 40.

The sheet folder 40 functions as a post-processing apparatus that performs a post-processing operation (sheet folding operation) on the sheet P having an image formed by the image forming apparatus 1 and conveys the sheet P to the sheet stacker 50.

As illustrated in FIG. 3, the sheet folding processing device 41 according to the present embodiment includes, for example, an entrance roller 42, a first folding roller 45, a second folding roller 44, a third folding roller 46, a first forward-reverse roller 43, a second forward-reverse roller 47, multiple motors including a first motor 201, a second motor 202 and a third motor 203, and multiple sheet detection sensors.

The first motor 201 is a motor that rotationally drives the entrance roller 42. The second motor 202 is a motor that rotationally drives the second folding roller 44 in the forward and reverse directions and, in accordance with the rotation of the second folding roller 44, that causes the first folding roller 45, the third folding roller 46, and the first forward-reverse roller 43 to rotate with the second folding roller 44. The third motor 203 is a motor that rotationally drives the second forward-reverse roller 47 in the forward and reverse directions.

The sheet folding processing device 41 performs, on the sheet P, a sheet folding operation, for example, a “Z-fold” as illustrated in FIG. 4A, a “letter fold-in” as illustrated in FIG. 4B, and a “letter fold-out” as illustrated in FIG. 4C. In other words, the sheet folding processing device 41 can select, by the user, to form the sheet Px subjected to the sheet folding operation in the three aspects illustrated in FIGS. 4A, 4B and 4C.

A description is given of the operations of the sheet folding processing device 41 when the sheet folding processing device 41 performs the Z-fold operation on the sheet P (see FIG. 4A), with reference to FIGS. 5A, 5B, 5C, 5D, 5E, 5F, 5G and 5H.

First, as illustrated in FIGS. 5A and 5B, as the leading end of the sheet P is detected by the first sheet detection sensor, the entrance roller 42 starts rotating. Then, as illustrated in FIG. 5C, the conveyance of the sheet P is continued from the time when the leading end of the sheet P is detected by the second sheet detection sensor until the protrusion amount of the leading end of the sheet P from the nip position between the first forward-reverse roller 43 and the second folding roller 44 reaches a given protrusion amount that varies according to, for example, the sheet length and the folding method.

Then, as illustrated in FIG. 5D, when the protrusion amount of the leading end of the sheet P reaches the given protrusion amount, the second folding roller 44, the first folding roller 45, and the first forward-reverse roller 43 start reverse rotation while the entrance roller 42 is being rotated. By so doing, a bend is formed in the sheet P, and the bend formed in the sheet P enters the nip region of the first folding roller 45 and the second folding roller 44, where the first fold is made.

Subsequently, as illustrated in FIG. 8E, the leading end of the sheet P that has the first fold is conveyed to the position of the second forward-reverse roller 47. Then, as illustrated in FIG. 8F, the sheet P is continuously conveyed from the time when the leading end of the sheet P is detected by the third sheet detection sensor until the protrusion amount of the leading end of the sheet P from the nip position of the second forward-reverse roller 47 reaches the given protrusion amount that varies according to, for example, the sheet length and the folding method.

Then, as illustrated in FIG. 5G, when the protrusion amount of the leading end of the sheet P reaches the given protrusion amount, the second forward-reverse roller 47 is rotated in the reverse direction while the first folding roller 45 is being rotated, folding the bend in the sheet P. Then, the thus formed bend enters the nip region formed between the second folding roller 44 and the third folding roller 46, where the second fold is made.

Accordingly, as illustrated in FIG. 5H, the sheet P having the second fold is conveyed by the second folding roller 44 and the third folding roller 46, and the sheet as the sheet Px subjected to the Z-fold operation is conveyed to the sheet stacker 50.

FIGS. 6A to 6H illustrate the operation of the sheet folding processing device 41 in a case where the letter fold-in operation is performed on the sheet P (see FIG. 4B).

FIGS. 7A to 7H illustrate the operation of the sheet folding processing device 41 in a case where the letter fold-out operation is performed on the sheet P (see FIG. 4C).

However, the basic operations of the letter fold-in operation and the letter fold-out operation are the same as the operations in FIGS. 5A to 5H described above, and the detailed descriptions of the letter fold-in operation and the letter fold-out operation will be omitted.

However, the letter fold-in operation illustrated in FIGS. 6A to 6H and the letter fold-out operation illustrated in FIGS. 7A to 7H are different from the Z-fold operation illustrated in FIGS. 5A to 5H in which the two protrusion amounts determined based on the sheet length and the folding method are different from each other. Along with the difference, the timings to start rotating the first forward-reverse roller 43 and the second forward-reverse roller 47 in the reverse direction are different from the timing of the Z-fold operation illustrated in FIGS. 5A to 5H.

Then, finally, in the configuration illustrated in FIGS. 6A to 6H, the sheet Px subjected to the letter fold-in operation by the sheet folding processing device 41 is conveyed toward the sheet stacker 50.

In the configuration of FIGS. 7A to 7H, the sheet Px subjected to the letter fold-out operation by the sheet folding processing device 41 is conveyed toward the sheet stacker 50.

A detailed description is given of the sheet stacker 50 of the image forming system 100 according to the present embodiment.

FIGS. 8A and 8B are diagrams illustrating the sheet stacker 50.

FIGS. 9A and 9B are diagrams illustrating a state where sheets subjected to a sheet folding operation freely fall in the sheet stacker 50.

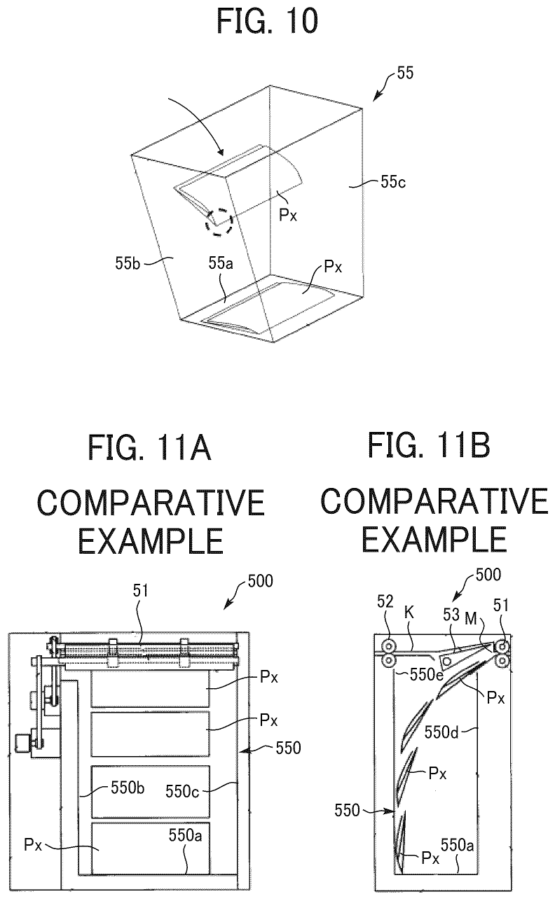

FIG. 10 is a perspective view of a state where a sheet subjected to a sheet folding operation freely falls in the sheet stacking portion 55.

Referring to FIGS. 8A to 10, the sheet stacker 50 according to the present embodiment includes, for example, the sheet stacking portion 55 in which the sheet Px subjected to the sheet folding operation is stackable (storable), the entrance roller 51, an ejection roller 52, a separation finger 53, multiple motors including a first motor 303 and a second motor 307, and multiple timing belts 304 and 308.

Above the sheet stacking portion 55, the conveyance path K on which the entrance roller 51 and the ejection roller 52 are disposed is formed. Further, the separation finger 53 is disposed on the upstream side of the conveyance path K (i.e., in the vicinity of the entrance roller 51). After the sheet P (Px) is conveyed from the sheet folder 40 to the sheet stacker 50 by the entrance roller 51, the separation finger 53 switches the destination of conveyance of the sheet P (Px) between the sheet stacking portion 55 and the conveyance path K.

In a case where the sheet P conveyed by the entrance roller 51 is not to be stored in the sheet stacking portion 55, the separation finger 53 rotates in a direction to open the conveyance path K (the state in FIGS. 8A and 8B). Then, the sheet P passes through the conveyance path K to be conveyed toward the sheet binder 90.

On the other hand, in a case where the sheet Px conveyed by the entrance roller 51 is to be stored in the sheet stacking portion 55, the separation finger 53 rotates in a direction to close the conveyance path K (the state that the ejection portion M is open to the sheet stacking portion 55 as in FIGS. 9A and 9B), and the sheet Px is ejected toward the sheet stacking portion 55. The sheet Px ejected from the ejection portion M falls to be stacked in the sheet stacking portion 55.

The first motor 303 is a motor to rotatably drive the entrance roller 51 and the ejection roller 52 via the timing belt 304. Further, the second motor 307 is a motor that drives the separation finger 53 to rotate in the forward and reverse directions via the timing belt 308.

Referring to FIGS. 8A to 10, the sheet stacker 50 according to the present embodiment includes the sheet stacking portion 55 having a substantially box-shape.

The sheet stacking portion 55 includes a bottom 55a, a first-end side portion 55b (one end side portion), a second-end side portion 55c (the other end side portion), an upstream side portion 55d, and a downstream side portion 55e. The bottom 55a, the first-end side portion 55b, the second-end side portion 55c, the upstream side portion 55d, and the downstream side portion 55e are formed in a plate shape.

The bottom 55a is a portion on which the sheet Px ejected from the ejection portion M in a sheet ejection direction freely falls to be stacked. In the present embodiment, the bottom 55a has a substantially horizontal stacker face.

The first-end side portion 55b (first side portion) is a portion that is raised upward with respect to the bottom 55a on one end (left side in FIG. 8A) in the width direction. The width direction is the direction orthogonal to the sheet ejection direction, which is the left-and-right direction in FIG. 8A and the vertical direction to the drawing sheet in FIG. 8B. In the sheet stacker 50, the driving mechanism (e.g., the first motor 303, the second motor 307, and the timing belts 304 and 308) is disposed on one end in the width direction.

The second-end side portion 55c (second side portion) is a portion that is raised upward with respect to the bottom 55a on the other end (right side in FIG. 8A) in the width direction. In the present embodiment, the second-end side portion 55c is raised upward substantially in the vertical direction.

The upstream side portion 55d is a portion that is raised upward with respect to the bottom 55a on the upstream side (right side in FIG. 8B) in the sheet ejection direction, which is the vertical direction to the drawing sheet in FIG. 8A and the vertical direction to the left-and-right direction in FIG. 8B. In the present embodiment, the upstream side portion 55d is raised upward substantially in the vertical direction. In the sheet stacker 50, the entrance roller 51 is disposed on the upstream side of the sheet ejection direction.

The downstream side portion 55e is a portion that is raised upward with respect to the bottom 55a on the downstream side (left side in FIG. 8B) in the sheet ejection direction. In the present embodiment, the downstream side portion 55e is raised upward substantially in the vertical direction. In the sheet stacker 50, the ejection roller 52 is disposed on the downstream side of the sheet ejection direction.

Referring to the drawings including FIGS. 8A, 9A, and 10A, the first-end side portion 55b of the sheet stacking portion 55 (of the sheet stacker 50) includes a sliding face in which one end in the width direction of the sheets Px that is ejected and free falls from the ejection portion M is slidably formed, and is inclined toward the other end (opposite end) in the width direction so that a distance from the first-end side portion 55b to the second-end side portion 55c (or the virtual plane being raised upward in the vertical direction on the other end in the width direction) reduces downward.

In the present embodiment, the first-end side portion 55b itself is inclined, and the side face (one end side face) of the first-end side portion 55b is the above-described sliding face (sloped face). Accordingly, in the present embodiment, the first-end side portion 55b is appropriately referred to as a “sliding face 55b” or a “sliding face 55b as one end side face”.

As described above, in the sheet stacker 50 according to the present embodiment, the first-end side portion 55b that is raised upward on the one end side in the width direction of the sheet stacking portion 55 is inclined. For this reason, it is less likely to cause an inconvenience that the sheet Px ejected to the sheet stacking portion 55 fails to maintain a substantially horizontal posture during the free fall and rotates.

Specifically, as illustrated in FIGS. 9A and 9B, when the sheet Px is discharged to the sheet stacking portion 55, the sheet Px collides with the downstream side portion 55e on the downstream side of the sheet ejection direction, and the speed of the sheet Px in the sheet ejection direction is reduced, and the sheet Px freely falls. At this time, immediately after the sheet Px is ejected to the sheet stacking portion 55, the sheet Px freely falls with the leading end (upstream end of the sheet ejection direction) of the sheet Px being inclined further downward when compared with the trailing end (upstream end of the sheet ejection direction). In other words, the sheet Px freely falls in the posture in which the sheet Px rotates as it is). However, when the end in the width direction of the sheet Px comes into contact (sliding contact) with the sliding face 55b (sloped face) as the one end side face that is inclined downward toward the center in the width direction, the falling speed of the lower side of the leading end and the trailing end of the sheet Px is reduced by the contact resistance. Accordingly, the posture of the sheet Px is corrected in a substantially horizontal direction, and the sheet Px is stacked on the bottom 55a while maintaining the substantially horizontal posture.

In other words, as in a sheet stacking portion 550 of a sheet stacker 500 illustrated in FIGS. 11A and 11B as a comparative example.

FIGS. 11A and 11B are diagrams illustrating a state where sheets subjected to a sheet folding operation freely fall in the sheet stacker 500 as a comparative example.

The sheet stacking portion 550 of the known sheet stacker 500 includes a bottom 550a and four side portions, which are a first-end side portion 550b, a second-end side portion 550c, an upstream side portion 550d, and a downstream side portion 550e. In a case where the side portions (i.e., the bottom 550a, the first-end side portion 550b, the second-end side portion 550c, the upstream side portion 550d and the downstream side portion 550e) are raised upward in a substantially vertical direction, in other words, in a case where the sliding face 55b (sloped face) is not provided, the posture of the sheet Px that freely falls so as to rotate fails to be corrected, and the sheet Px is vertically and horizontally reversed and reaches the bottom 550a (FIG. 11B) or is reversed and reaches the bottom 550a, resulting in a stacking failure.

In particular, such an inconvenience is likely to occur when the sheet that is ejected and freely falls from the ejection portion M is a sheet having a short length in the sheet ejection direction (conveyance direction), such as the sheet Px subjected to the sheet folding operation.

In contrast, in the present embodiment, since the first-end side portion 55b on the one end in the width direction among the four side portions, which are the bottom 55a, the first-end side portion 55b, the second-end side portion 55c, the upstream side portion 55d, and the downstream side portion 55e, of the sheet stacking portion 55 is inclined and is raised upward, a force of correcting the posture acts on the sheet Px that freely falls so as to rotate, so that it is less likely that a stacking failure of the sheets Px on the bottom 55a occur.

In the present embodiment, the number of rotations (conveyance speed) of the entrance roller 51 that conveys the sheet Px to the sheet stacking portion 55 can be controlled to be sufficiently reduced so that the sheet Px that is ejected to the sheet stacking portion 55 is less likely to be in a posture in which the sheet Px rotates.

Further, in the present embodiment, the sheet Px subjected to the sheet folding operation is ejected to the sheet stacking portion 55 is described. However, even in a case where the sheet P having a short length in the sheet ejection direction without performing the sheet folding operation on the sheet P, the same effect as the above-described effect to prevent the stacking failure can be achieved.

Referring to the drawings such as FIG. 9A, in the sheet stacking portion 55 according to the present embodiment, the sliding face 55b as a one end side face has an upper end 55b1. The upper end 55b1 of the sliding face 55b is located on one end in the width direction (left side in FIG. 9A) close than the position of one end (left end in FIG. 9A) immediately after ejection of the sheet Px having the maximum size ejectable from the ejection portion M.

Due to such a configuration, even when the sheet Px of the maximum size is ejected to the sheet stacking portion 55, the one end in the width direction of the sheet Px constantly freely falls while sliding on the sliding face 55b (sloped face), and thus the effect that can prevent the above-described stacking failure can be achieved.

As illustrated in FIG. 9A, in the present embodiment, the sliding face 55b (sloped face) has a lower end 55b2. The lower end 55b2 of the sliding face 55b is located on the one end in the width direction (left side in FIG. 9A) from the center in the width direction of the sheet Px that is ejected from the ejection portion M on the center reference. In contrast, the lower end 55b2 of the sliding face 55b may be set to be located on the other end in the width direction (right side in FIG. 9A) from the center in the width direction of the sheet Px that is ejected from the ejection portion M on the center reference.

### Modification 1

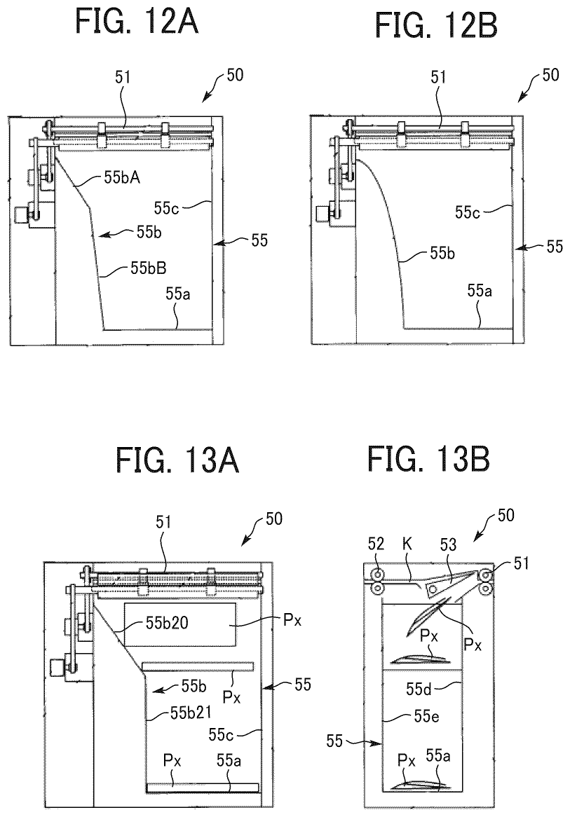

FIGS. 12A and 12B are diagrams illustrating the sheet stacker 50 according to Modification 1 of the embodiments of the present disclosure.

As illustrated in FIG. 12A, in the sheet stacker 50 according to Modification 1, the sliding face 55b (first-end side portion) of the sheet stacking portion 55 is formed such that the ratio of decreasing downward in the distance from the sliding face 55b to the second-end side portion 55c is smaller in the lower part compared to the upper part.

Specifically, the sliding face 55b (first-end side portion) illustrated in FIG. 12A is formed by connecting two sliding faces, which are an upper sliding face 55bA and a lower sliding face 55bB, having different angles of inclination. The ratio of reduction of the opposite distance of the lower sliding face 55bB of the sliding face 55b and the second-end side portion 55c is smaller than the ratio of reduction of the distance from the upper sliding face 55bA of the sliding face 55b to the second-end side portion 55c. In other words, the upper sliding face 55bA is inclined at the angle closer to the horizontal plane than the angle of the lower sliding face 55bB to the horizontal plane, and the lower sliding face 55bB is inclined at the angle closer to the vertical plane than the angle of the upper sliding face 55bA to the vertical plane.

Due to such a configuration as described above, the sheet Px ejected to the sheet stacking portion 55 comes into contact relatively early with the upper sliding face 55bA closer to the horizontal plane, and the posture of the sheet Px can be stabilized in an early stage. However, when the upper sliding face 55bA is too close to the plane, the sheet Px is prevented from freely falling and is inclined in the width direction. For this reason, it is preferable that, as a guide, the angle of the upper sliding face 55bA with respect to the horizontal plane is set to 45 degrees or more.

The sliding face 55b (first-end side portion) of the sheet stacking portion 55 illustrated in FIG. 12B is formed to be curved toward the other end side in the width direction so that the distance from the sliding face 55b to the second-end side portion 55c is reduced downward. Then, the sliding face 55b formed to have a curved face has the ratio of reduction of the distance from the sliding face 55b to the second-end side portion 55c downward is smaller in the lower part than the upper part. In other words, the sliding face 55b is formed so that the ratio of reduction of the opposite distance gradually decreases. Due to such a configuration as described above, the sheet Px ejected to the sheet stacking portion 55 comes into contact relatively early to the upper part of the sliding face 55b, and the posture of the sheet Px can be stabilized in an early stage.

Even in a case where the sheet stacking portion 55 is configured as described above, the stacking failure of the sheet Px can be less likely to occur.

### Modification 2

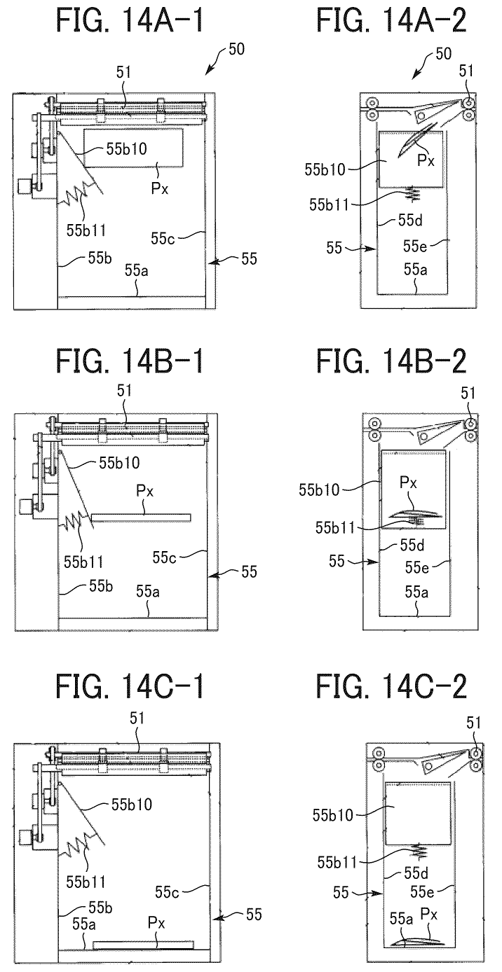

FIGS. 13A and 13B are diagrams illustrating the sheet stacker 50 according to Modification 2 of the embodiments of the present disclosure.

As illustrated in FIGS. 13A and 13B, in the sheet stacker 50 according to Modification 2, the sliding face 55b (first-end side portion) of the sheet stacking portion 55 is different from the sliding face 55b of the sheet stacking portion 55 in FIG. 12A. Specifically, the upper sliding face 55b20 is a sloped face, and the lower sliding face 55b21 is substantially a vertical face.

Even with such a configuration, as illustrated in FIGS. 13A and 13B, the posture of the sheet Px ejected to the sheet stacking portion 55 is corrected to the horizontal plane as the sheet Px falls while sliding on the upper sliding face 55b20 (sloped face). After this correction, the sheet Px falls along the lower sliding face 55b21.

Even in a case where the sheet stacking portion 55 is configured as described above, the stacking failure of the sheet Px can be less likely to occur.

### Modification 3

FIGS. 14A-1, 14A-2, 14B-1, 14B-2, 14C-1 and 14C-2 are diagrams illustrating a state where a sheet subjected to a sheet folding operation freely falls in the sheet stacker 50 according to Modification 3 of the embodiments of the present disclosure.

As illustrated in FIGS. 14A-1, 14A-2, 14B-1, 14B-2, 14C-1 and 14C-2, in the sheet stacker 50 according to Modification 3, the sheet stacking portion 55 has a part (sliding contact portion 55b10) that functions as a sliding face, and the part is coupled to a part of the first-end side portion 55b that is raised upward in the vertical direction and is separated to the first-end side portion 55b.

As illustrated in FIGS. 14A-1, 14A-2, 14B-1, 14B-2, 14C-1 and 14C-2, in Modification 3, the sliding contact portion 55b10 (sliding face) is rotatably disposed about the upper end of the first-end side portion 55b. Further, the sliding contact portion 55b10 is biased by a compression spring 55b11 as a biasing member in the direction closer to the horizontal plane.

When the one end of the sheet Px that is ejected and free falls from the ejection portion M is not in sliding contact with the sliding contact portion 55b10, the sliding contact portion 55b10 is biased by the compression spring 55b11 (biasing member) and is positioned at a reference rotation position (FIGS. 14A-1 and 14A-2). When the one end of the sheet Px comes into sliding contact with the sliding contact portion 55b10, the sliding contact portion 55b10 is pushed in by the sheet Px and rotates in the clockwise direction of FIG. 14B-1 from the reference rotation position against the biasing force of the compression spring 55b11. At this time, the sheet Px comes into contact with the sliding contact portion 55b10, and the posture of the sheet Px is corrected to be substantially horizontal, and the sheet Px is stacked on the bottom 55a in this state. Then, the sliding contact portion 55b10 that is no longer in contact with the sheet Px is biased by the compression spring 55b11, and returns to the reference rotation position (FIGS. 14C-1 and 14C-2) again.

Even in a case where the sheet stacking portion 55 is configured as described above, the stacking failure of the sheet Px can be less likely to occur. In particular, in Modification 3, the posture of the sheet Px is corrected at the initial stage of the free fall. After the correction, the sheet Px receives the weight of the sheet P and rotates (retreats) so that the sliding contact portion 55b10 becomes close to vertical. Due to such a configuration, the volume of the sheet stacking portion 55 can be utilized to the maximum.

### Modification 4

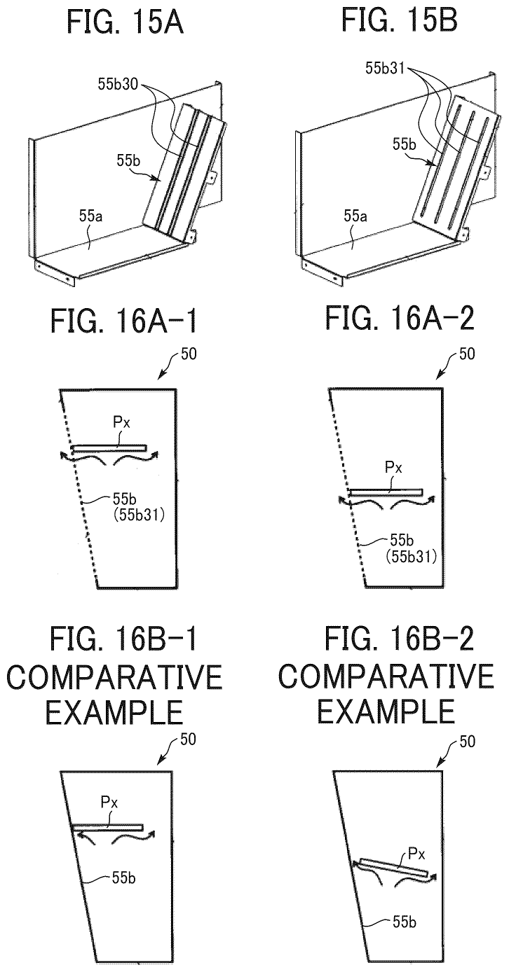

FIGS. 15A and 15B are perspective views of a main part of the sheet stacker 50 according to Modification 4 of the embodiments of the present disclosure.

As illustrated in FIG. 15A, the sliding face 55b (first-end side portion) of the sheet stacking portion 55 of the sheet stacker 50 according to Modification 4 has multiple grooves 55b30 extending in the vertical direction at intervals in the sheet ejection direction.

Further, as illustrated in FIG. 15B, the sliding face 55b (first-end side portion) of the sheet stacking portion 55 of the sheet stacker 50 according to Modification 4 has multiple holes 55b31 extending in the vertical direction at intervals in the sheet ejection direction.

FIGS. 16A-1 and 16A-2 are diagrams illustrating a state where a sheet freely falls in the sheet stacker 50 according to Modification 4 of the embodiments of the present disclosure.

FIGS. 16B-1 and 16B-2 are diagrams illustrating a state where a sheet freely falls in the sheet stacker 50 as a comparative example.

With this configuration, as illustrated in FIGS. 16A-1 and 16A-2, the air received by the lower face of the sheet Px in the course of the free fall of the sheet Px is released through the holes 55b31 (or the grooves 55b30), in other words, through a space for releasing the air is formed. For this reason, the posture of the sheet Px is less likely to be changed by the air resistance.

In other words, as illustrated in FIGS. 16B-1 and 16B-2 as a comparative example, when the holes 55b31 or the grooves 55b30 are not formed in the sliding face 55b, the air received by the lower face of the sheet Px in the course of the free fall of the sheet Px is not released, and the posture of the sheet Px is likely to change due to the air resistance.

In contrast, with the configuration of the sheet stacking portion 55 according to Modification 4, the stacking failure of the sheet Px can be less likely to occur.

### Modification 5

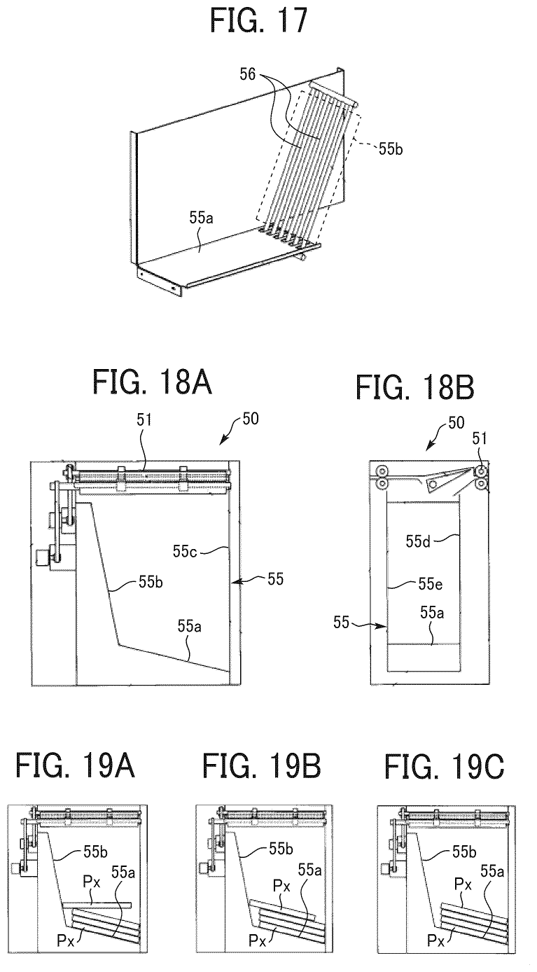

FIG. 17 is a perspective view of a main part of the sheet stacker 50 according to Modification 5 of the embodiments of the present disclosure.

As illustrated in FIG. 17, in the sheet stacking portion 55 of the sheet stacker 50 according to Modification 5, the sliding face 55b is a virtual plane formed by multiple rod-shaped members 56 that extend downward and aligned at intervals in the sheet ejection direction.

In other words, a virtual plane formed by tying the top ends of the circular cross sections of the multiple rod-shaped members 56 functions as the sliding face 55b.

Even in a case where the sheet stacking portion 55 is configured as described above, the stacking failure of the sheet Px can be less likely to occur. With this configuration, in Modification 5, as illustrated in FIGS. 15A, 15B, 16A-1, 16A-2, 16B-1 and 16B-2, the air received by the lower face of the sheet Px in the course of the free fall of the sheet Px along the sliding face 55b is released through a space for releasing the air is formed. For this reason, the posture of the sheet Px is less likely to be changed by the air resistance.

### Modification 6

### Modification 6

FIGS. 18A and 18B are diagrams illustrating the sheet stacker 50 according to Modification 6 of the embodiments of the present disclosure.

FIGS. 19A, 19B and 19C are diagrams illustrating a state where sheets subjected to a sheet folding operation freely fall in the sheet stacker 50 of FIGS. 18A and 18B.

As illustrated in FIGS. 18A, 18B, 19A, 19B and 19C, in the sheet stacking portion 55 of the sheet stacker 50 according to Modification 6, the bottom 55a is inclined from one end in the width direction (left side in FIGS. 18A, 19A, 19B and 19C) toward the other end (opposite end) in the width direction (right side in FIGS. 18A, 19A, 19B and 19C) downward.

Even in a case where the sheet stacking portion 55 is configured as described above, the stacking failure of the sheet Px can be less likely to occur. In particular, in Modification 6, when the sheet Px whose posture is corrected to be substantially horizontal by contact with the sliding face 55b is stacked on the bottom 55a of the sheet stacking portion 55, the sheet Px slides down along the inclination of the bottom 55a and contacts the second-end side portion 55c to be positioned, so that the alignment of the bundle of the sheets Px stacked on the bottom 55a can be enhanced. Further, when the bottom 55a is inclined, the widthwise size of the sheet Px stackable on the bottom 55a can be increased as compared with the case where the bottom 55a is not inclined.

### Modification 7

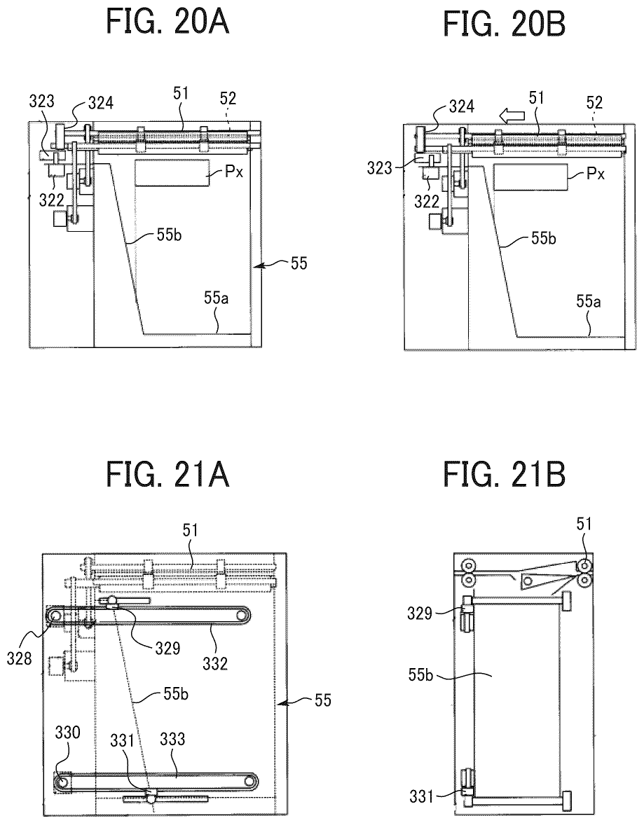

FIGS. 20A and 20B are diagrams illustrating the sheet stacker 50 according to Modification 7 of the embodiments of the present disclosure.

As illustrated in FIGS. 20A and 20B, the sheet stacker 50 according to Modification 7 includes a movement mechanism (such as a shift motor 322, a shift gear 323, and a coupling member 324) that moves the relative position of the sliding face 55b in the width direction with respect to the sheet Px to be ejected from the ejection portion M, according to at least one of the type and the size in the width direction of the sheet Px to be ejected from the ejection portion M.

The movement mechanism according to Modification 7 includes a shift motor 322, a shift gear 323, and a coupling member 324 to move the entrance roller 51 (and the ejection roller 52) in the width direction (left-right direction in FIGS. 20A and 20B). The shift gear 323 is engaged with the motor gear of the shift motor 322, and is coupled to the coupling member 324 together with the entrance roller 51 and the ejection roller 52. As the shift motor 322 rotates in the forward direction, the entrance roller 51 and the ejection roller 52 move in the forward direction (direction indicted by white arrow) from the position illustrated in FIG. 20A to the position illustrated in FIG. 20B. Similarly, when the shift motor 322 rotates in the reverse direction, the entrance roller 51 and the ejection roller 52 move in the reverse direction.

When the size of the sheet Px to be ejected onto the sheet stacking portion 55 in the width direction is small, the movement mechanism (i.e., the shift motor 322) is controlled so that the entrance roller 51 (and the ejection roller 52) is positioned on one end in the width direction as compared with the case where the size of the sheet Px in the width direction is large. Due to such a configuration, regardless of the widthwise size of the sheet Px to be ejected to the sheet stacking portion 55, the one end of the sheet Px is brought into contact with the sliding face 55b at substantially the same timing, and the posture of the sheet Px can be stably corrected.

When the type of the sheet Px to be ejected onto the sheet stacking portion 55 is difficult to be bent, the movement mechanism (i.e., the shift motor 322) is controlled so that the entrance roller 51 (and the ejection roller 52) is positioned on one end in the width direction as compared with the case where the type of the sheet Px in the width direction is easy to be bent. Due to such a configuration, even when the sheet Px to be ejected to the sheet stacking portion 55 is difficult to be bent, the one end of the sheet Px is brought into contact with the sliding face 55b in an early stage, and the sheet Px can take time to correct the posture.

### Modification 8

FIGS. 21A and 21B are diagrams illustrating the sheet stacker 50 according to Modification 8 of the embodiments of the present disclosure.

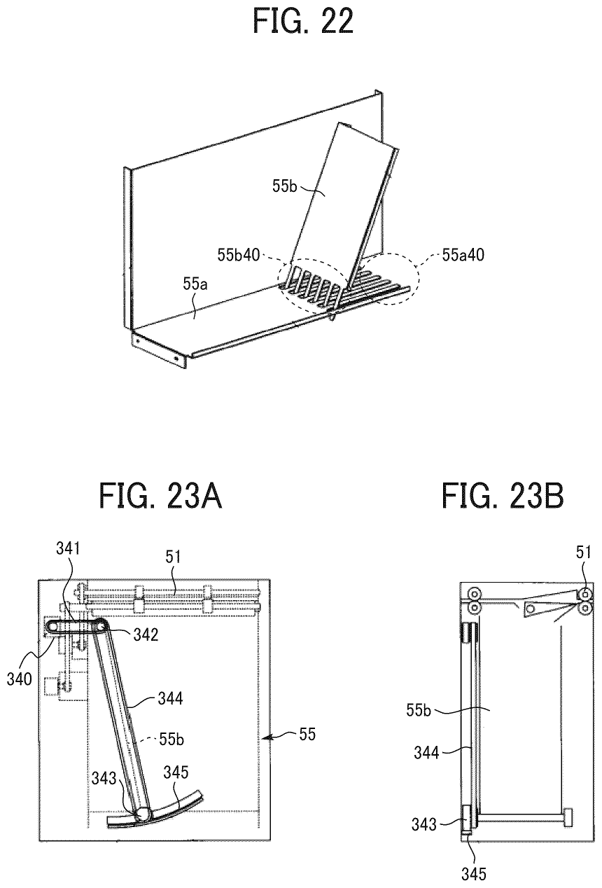

FIG. 22 is a perspective view of a main part of the sheet stacker 50 of FIGS. 21A and 21B.

As illustrated in FIGS. 21A, 21B and 22, similarly to the sheet stacker 50 according to Modification 7 illustrated in FIGS. 20A and 20B, the sheet stacker 50 according to Modification 8 includes a movement mechanism (such as two motors 328 and 330, two guides 329 and 331, and two timing belts 332 and 333) that moves the relative position of the sliding face 55b in the width direction with respect to the sheet Px to be ejected from the ejection portion M, according to at least one of the type and the size in the width direction of the sheet Px to be ejected from the ejection portion M.

However, different from the movement mechanism according to Modification 7 illustrated in FIGS. 20A and 20B, in the movement mechanism according to Modification 8, the sliding face 55b (first-end side portion) itself is movable in the width direction.

Specifically, the guide 329 that supports the upper end of the sliding face 55b is held by the timing belt 332 that travels in the forward and reverse directions by forward and reverse rotations of the motor 328. Specifically, the guide 331 that supports the lower end of the sliding face 55b is held by the timing belt 333 that travels in the forward and reverse directions by forward and reverse rotations of the motor 330. Due to such a configuration as described above, as the two motors 328 and 330 are rotated in the forward and reverse directions in synchronization with each other, the sliding face 55b moves in the width direction while maintaining the angle of inclination of the sliding face 55b.

In order to cause the sliding face 55b to move in the width direction, as illustrated in FIG. 22, the sliding face 55b has a lower end 55b40 having a pectinated shape, so that the pectinated portion of the lower end 55b40 can engage with holes 55a40 having the pectinated shape formed in the bottom 55a.

When the size of the sheet Px to be ejected onto the sheet stacking portion 55 in the width direction is small, the movement mechanism (i.e., the motors 328 and 330) is controlled so that the sliding face 55b is positioned on the other end in the width direction as compared with the case where the size of the sheet Px in the width direction is large. Due to such a configuration, regardless of the widthwise size of the sheet Px to be ejected to the sheet stacking portion 55, the one end of the sheet Px is brought into contact with the sliding face 55b at substantially the same timing, and the posture of the sheet Px can be stably corrected.

When the type of the sheet Px to be ejected onto the sheet stacking portion 55 is difficult to be bent, the movement mechanism (i.e., the motors 328 and 330) is controlled so that the sliding face 55b is positioned on the other end in the width direction as compared with the case where the type of the sheet Px in the width direction is easy to be bent. Due to such a configuration, even when the sheet Px to be ejected to the sheet stacking portion 55 is difficult to be bent, the one end of the sheet Px is brought into contact with the sliding face 55b in an early stage, and the sheet Px can take time to correct the posture.

### Modification 9

FIGS. 23A and 23B are diagrams illustrating the sheet stacker 50 according to Modification 9 of the embodiments of the present disclosure.

As illustrated in FIGS. 23A and 23B, the sheet stacker 50 according to Modification 9 includes a rotation mechanism (such as a motor 340, a timing belt 341, a first roller 342, a second roller 343, a holder 344, and a guide rail 345) that moves sliding face 55b (first-end side portion) about the upper end according to at least one of the type and size in the width direction of the sheet Px to be ejected from the ejection portion M.

Specifically, the rotation mechanism includes a holder 344 that holds the sliding face 55b (first-end side portion). the first roller 342 coupled to the upper end of the holder 344, a second roller 343 coupled to the lower end of the holder 344, the motor 340 to rotate the first roller 342 in the forward and reverse directions via the timing belt 341, and the guide rail 345 to guide the second roller 343 to rotate along the rotation trajectory pf the second roller 343. According to the configuration as described above, as the rotation mechanism, which are the motor 340, the timing belt 341, the first roller 342, the second roller 343, the holder 344, and the guide rail 345, rotates in the forward and reverse directions, the sliding face 55b (first-end side portion) rotates about the first roller 342 (upper end) in the forward and reverse directions.

When the size of the sheet Px to be ejected onto the sheet stacking portion 55 in the width direction is small, the rotation mechanism (i.e., the motor 340) is controlled to rotate in the counterclockwise direction in FIG. 23A so that the sheet Px constantly contacts the sliding face 55b at the stable height position in height as compared with the case where the size of the sheet Px in the width direction is large. Due to such a configuration, regardless of the widthwise size of the sheet Px to be ejected to the sheet stacking portion 55, the one end of the sheet Px is brought into contact with the sliding face 55b at substantially the same timing, and the posture of the sheet Px can be stably corrected.

Further, when the type of the sheet Px to be ejected onto the sheet stacking portion 55 is difficult to be bent, the rotation mechanism (i.e., the motor 340) is controlled to rotate in the counterclockwise direction in FIG. 23A so that the sheet Px constantly contacts the sliding face 55b at the stable height position in height as compared with the case where the type of the sheet Px is easy to be bent. Due to such a configuration, even when the sheet Px to be ejected to the sheet stacking portion 55 is difficult to be bent, the one end of the sheet Px is brought into contact with the sliding face 55b in an early stage, and the sheet Px can take time to correct the posture.

### Modification 10

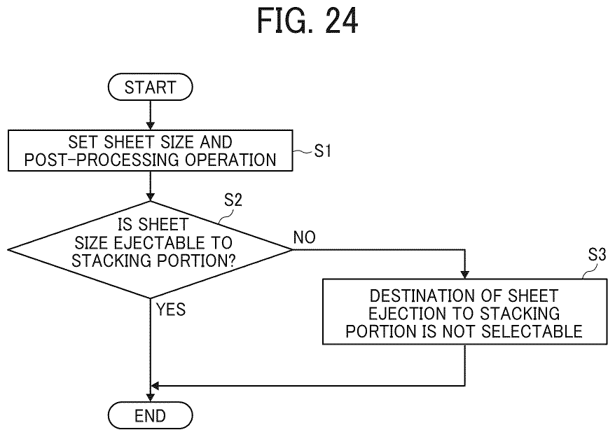

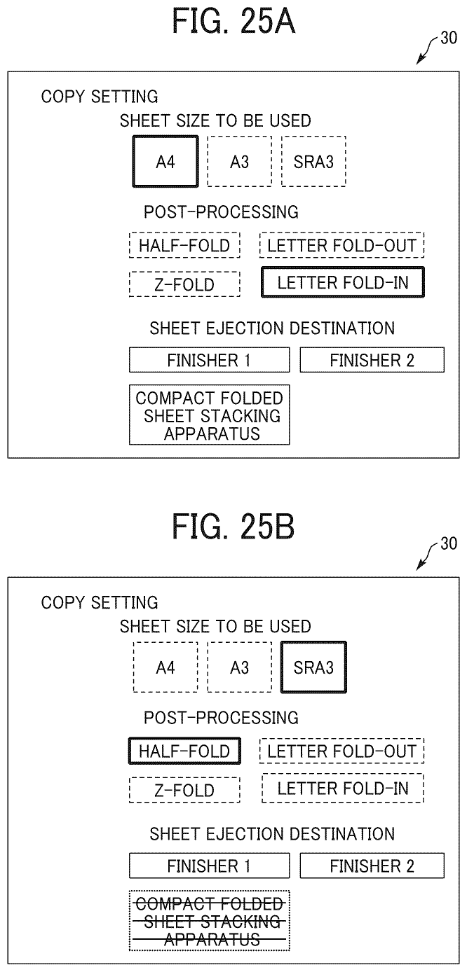

FIG. 24 is a flowchart of a control process executed in the sheet stacker 50 according to Modification 10 of the embodiments of the present disclosure.
FIGS. 25A and 25B are diagrams illustrating an example of a display on the operation display panel 30 when the control of FIG. 24 is executed.

As illustrated in FIG. 24, the sheet stacker 50 according to Modification 10 controls the sheet P not to be ejected from the ejection portion M when it is determined that the ejection of the sheet P from the ejection portion M is not appropriate, based on the information on the sheet P conveyed to the sheet stacker 50 (mainly, information of the sheet size in the sheet ejection direction) and the information of the post-processing performed on the sheet P (mainly, information of the sheet folding operation).

In other words, the sheet stacker 50 according to Modification 10 controls so that the sheet Px having a size that is not storable in the sheet stacking portion 55 is not ejected to the sheet stacking portion 55.

In detail, as illustrated in FIG. 24, the sheet size in the printing operation and the type of the sheet folding operation (post-processing operation) are input (set) to the operation display panel 30 by the user (step S1). Then, it is determined whether the sheet Px can be ejected (is ejectable) to the sheet stacking portion 55 based on the size of the sheet Px subjected to the sheet folding operation (step S2).

As a result, when it is determined that the sheet Px can be ejected to the sheet stacking portion 55 (YES in step S2), the sheet Px can be ejected to the sheet stacking portion 55 of the sheet stacker 50 as it is. For example, as illustrated in FIG. 25A, when the setting for performing the letter fold-in process is performed on the sheet P of the A4 size is made on the operation display panel 30, the sheet Px can be ejected to the sheet stacking portion 55 of the sheet stacker 50 (compact folded sheet stacking apparatus), and thus a screen window is displayed so that the sheet stacker 50 (compact folded sheet stacking apparatus) can be selected as the ejection destination of the sheet Px.

On the other hand, when it is determined that the sheet Px is not ejectable to the sheet stacking portion 55 (NO in step S2), the destination of ejection of the sheet Px to the sheet stacking portion 55 of the sheet stacker 50 is not selectable (step S3). For example, as illustrated in FIG. 25B, when the setting for performing the half-fold process is performed on the sheet P of the SRA3 size is made on the operation display panel 30, the sheet Px is not ejectable to the sheet stacking portion 55 of the sheet stacker 50 (compact folded sheet stacking apparatus). For this reason, the screen window is displayed so that the sheet stacker 50 (compact folded sheet stacking apparatus) is not selectable as the ejection destination of the sheet Px. In this case, another selectable ejection destination is to be selected.

As the control described above is executed, an inconvenience that the sheet Px that is not storable in the sheet stacking portion 55 is ejected can be prevented.

### Modification 11

FIG. 26 is a drawing illustrating the main part of the sheet folder 40 according to Modification 11.

As illustrated in FIG. 26, different from the sheet folding processing device 41 of the sheet folder 40 illustrated in FIG. 3, the sheet folding processing device 41 of the sheet folder 40 according to Modification 11 can rotate the third folding roller 48 and the first folding roller 45 by the driving by the forward-reverse rotation motor 204, as a device that performs the second fold on the sheet P. The lower branched conveyance path includes a second forward-reverse roller 47 that is rotatable in the forward and reverse directions by the second forward-reverse rotation motor that is the third motor 203.

Even in the image forming system 100 including the sheet folder 40 having the configuration described above, a stacking failure of the sheet Px conveyed from the sheet folder 40 to the sheet stacker 50 can be reduced to occur.

### Modification 12

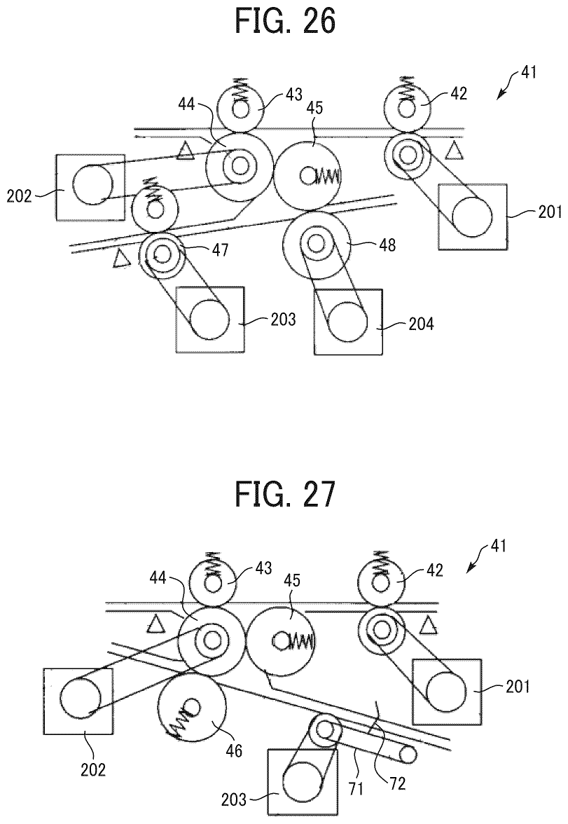

FIG. 27 is a diagram illustrating the main part of the sheet folder 40 according to Modification 12.

As illustrated in FIG. 27, instead of the second forward-reverse roller 47 illustrated in FIG. 3, the sheet folding processing device 41 of the sheet folder 40 according to Modification 12 includes a leading end stopper 72 to move on the branched conveyance path via a conveyance belt 71 driven by the second forward-reverse rotation motor (third motor) 203. The leading end stopper 72 adjusts the protrusion amount (conveyance amount) of the sheet P conveyed to the branched conveyance path as the second forward-reverse roller 47 illustrated in FIG. 3.

Even in the image forming system 100 including the sheet folder 40 having the configuration described above, a stacking failure of the sheet Px conveyed from the sheet folder 40 to the sheet stacker 50 can be reduced to occur.

### Modification 13

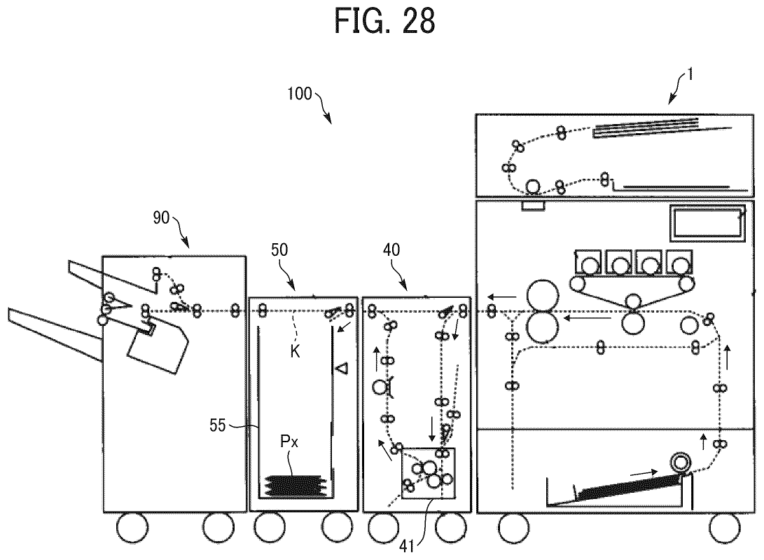

FIG. 28 is a diagram illustrating the overall configuration of the image forming system 100 according to Modification 13 of an embodiment of the present disclosure.

As illustrated in FIG. 28, different from the image forming system 100 illustrated in FIG. 1, an image forming system 100 according to Modification 13 does not have an in-body space in the image forming apparatus 1 but includes a console-type sheet folder 40 disposed (coupled to) between the image forming apparatus 1 and the sheet stacker 50.

Even in the case where the image forming system 100 has the configuration described above in FIG. 28, the occurrence of a stacking failure of the sheet Px conveyed from the sheet folder 40 to the sheet stacker 50 can be reduced.

As described above, the sheet stacker 50 according to the present embodiment includes the bottom 55a on which the sheet Px subjected to the sheet folding operation is stackable and storable after the sheet Px is ejected and falls from the ejection portion M in the sheet ejection direction, the first-end side portion 55b that is raised upward with respect to the bottom 55a on one end in the width direction orthogonal to the sheet ejection direction, the second-end side portion 55c that is raised upward with respect to the bottom 55a on the other end in the width direction. The first-end side portion 55b has the sliding face that is formed so that the one end in the width direction of the sheet Px subjected to the sheet folding operation after the sheet Px is ejected and falls from the ejection portion M is slidable. The sliding face is inclined (or curved) downward to the other end (opposite end) in the width direction.

According to this configuration, even when the sheet Px ejected from the ejection portion M is to free fall toward the bottom 55a to be stacked on the bottom 55a, the stacking failure can be reduced or prevented.

The image forming system 100 according to the present disclosure employs the image forming apparatus 1 that performs image formation with color toners. However, the configuration of the image forming apparatus and the image forming system are not limited to the above-described configurations. For example, an image forming system that employs a monochrome image forming apparatus is also applicable to achieve the effect of the present disclosure.

Further, in the present embodiment, the image forming apparatus 1 is an electrophotographic image forming apparatus and the image forming system 100 includes the image forming apparatus 1 as an electrophotographic image forming apparatus. However, the embodiments of the present disclosure are not limited to the electrophotographic image forming apparatus. In some embodiment, for example, the image forming apparatus may be an image forming apparatus of another system (for example, an image forming apparatus of an inkjet system or a stencil printer).

Further, in the present embodiment, a post-processing apparatus (i.e., the sheet binder 90) that performs a sheet binding operation is provided downstream from the sheet stacker 50 in the sheet conveyance direction. However, a post-processing apparatus that performs another operation (for example, a punching operation or a sorting operation) may be provided downstream in the sheet conveyance direction, or a post-processing apparatus may not be provided downstream in the sheet conveyance direction.

Further, in the present embodiment, the first-end side portion 55b having the sliding face (sloped face) is located on the left side of FIG. 9A and the second-end side portion 55c is located on the right side of FIG. 9A. However, the positions of the first-end side portion 55b and the second-end side portion 55c are not limited to the above-described positions. For example, the first-end side portion 55b having the sliding face (sloped face) may be located on the right side of FIG. 9A and the second-end side portion 55c may be located on the left side of FIG. 9A.

Any of the cases described above exhibits substantially the same advantages as the advantages of the present embodiment.

The present disclosure is not limited to the above-described embodiment, modifications, and variations, and the configuration of the present embodiment can be appropriately modified other than suggested in the above embodiment, modifications, and variations within a scope of the technological concept of the present disclosure. Further, features of components of the embodiments, such as the number, the position, and the shape are not limited to the embodiments and thus may be preferably set to be applied to the present disclosure.

It is to be noted that the sheet P in this specification is not limited to indicate a paper but also defined as a sheet-like recording medium including any other sheet-like recording medium such as a coated paper sheet, a label paper, and an overhead projector (OHP) transparencies.

The present disclosure may be applicable to, for example, a combination of the following aspects.

### Aspect 1

In Aspect 1, a sheet stacker includes a bottom, a first-end side portion, and a second-end side portion. The bottom is a portion on which a sheet subjected to a folding operation is output from an ejection portion in a sheet ejection direction is placed after a free fall of the sheet. The first-end side portion is raised upward with respect to the bottom at a first end in a width direction orthogonal to the sheet ejection direction. The second-end side portion is raised upward with respect to the bottom at a second end in the width direction. The first-end side portion includes a sliding face in which the first end in the width direction of the sheet subjected to the folding operation and ejected from the ejection portion after the free fall is slidably formed. The sliding face is to be inclined or curved downward toward the second end.

### Aspect 2

In Aspect 2, in the sheet stacker according to Aspect 1, the second-end side portion is raised upward in a substantially vertical direction.

### Aspect 3

In Aspect 3, in the sheet stacker according to Aspect 1 or 2, the sliding face has an upper end that is located closer to the first end in the width direction than the position at the first end immediately after an ejection of a maximum size sheet that is ejectable from the ejection portion.

### Aspect 4

In Aspect 4, in the sheet stacker according to any one of Aspects 1 to 3, the sliding face has a ratio of reducing a distance from the lower sliding portion of the sliding face to the second-end side portion downward to be smaller than a ratio of reducing a distance from the upper sliding portion of the sliding face to the second-end side portion downward.

### Aspect 5

In Aspect 5, in the sheet stacker according to any one of Aspects 1 to 4, the sliding face is disposed to be rotatable about an upper end of the sliding face. The sliding face is biased by a biasing member to be located at a reference rotation position when the first-end side portion of the sheet that is ejected from the ejection portion and freely falls from the ejected portion is not in sliding contact with the sliding face, and is rotated from the reference rotation position against the biasing force of the biasing member when the first-end side portion of the sheet is in sliding contact with the sliding face.

### Aspect 6

In Aspect 6, in the sheet stacker according to any one of Aspects 1 to 5, the sliding face has an opening or a groove.

### Aspect 7

In Aspect 7, in the sheet stacker according to any one of Aspects 1 to 5, the sliding face is formed by multiple rod-shaped members that extend downward and are arranged at intervals in the sheet ejection direction.

### Aspect 8

In Aspect 8, in the sheet stacker according to any one of Aspects 1 to 7, the bottom is inclined downward from one end of the width direction toward the other end (opposite end).

### Aspect 9

In Aspect 9, the sheet stacker according to any one of Aspects 1 to 8 further includes a moving mechanism to move the relative positions of the sliding face in the width direction with respect to the sheet to be ejected from the ejection portion, in accordance with at least one of a type of the sheet ejected from the ejection portion or a size in the width direction of the sheet ejected from the ejection portion.

### Aspect 10

In Aspect 10, the sheet stacker according to any one of Aspects 1 to 8 further includes a rotation mechanism to rotate the sliding face about the upper end of the sliding face in accordance with at least one of the type of the sheet ejected from the ejection portion or a size in the width direction of the sheet ejected from the ejection portion.

### Aspect 11

In Aspect 11, in the sheet stacker according to any one of Aspects 1 to 10, wherein when it is determined that the ejection of the sheet from the ejection portion is not appropriate based on information of the sheet fed into the sheet stacker and information of a post-processing to be performed on the sheet, a control is performed so that the sheet is not ejected from the ejection portion.

### Aspect 12

In Aspect 12, an image forming system includes the sheet stacker according to any one of Aspects 1 to 11, an image forming apparatus that forms an image on a sheet, and a post-processing apparatus to perform a folding operation on the sheet with the image formed by the image forming apparatus and convey the sheet to the sheet stacker.

### Aspect 13

In Aspect 13, a sheet stacker includes a bottom face, a first-end side portion, and a second-end side portion. The bottom face is a face on which a sheet, subjected to a folding operation and ejected from an ejection portion in a sheet ejection direction, is stacked. The first-end side portion has a sliding face that is raised upward from the bottom face at a first end of the bottom face in a width direction orthogonal to the sheet ejection direction. The second-end side portion is raised upward from the bottom face at a second end opposite to the first end in the width direction. The sliding face of the first-end side portion is inclined or curved with respect to a vertical plane.

### Aspect 14

In Aspect 14, in the sheet stacker according to Aspect 13, the second-end side portion is raised vertically upward from the bottom face at the second end. The sliding face of the first-end side portion is inclined or curved with respect to a vertical face of the second-end side portion. The first-end side portion approaches the second-end side portion in the width direction toward the bottom face.

### Aspect 15

In Aspect 15, in the sheet stacker according to Aspect 13 or 14, the sliding face of the first-end side portion has an upper end. The ejection portion ejects the sheet having a maximum size, one side edge of which closer to the first end is at an ejection position at the ejection portion during an ejection of the sheet from the ejection portion. The ejection position is farther from the second end by a first distance in the width direction. The upper end is farther from the first end by a second distance larger than the first distance in the width direction.

### Aspect 16

In Aspect 16, in the sheet stacker according to any one of Aspects 13 to 15, the sliding face has an inclination angle with respect to the vertical plane. The inclination angle decreases toward the bottom face.

### Aspect 17

In Aspect 17, in the sheet stacker according to any one of Aspects 13 to 16, the sliding face has an upper sliding portion having a first inclination angle with respect to the vertical plane, and a lower sliding portion having a second inclination angle with respect to the vertical plane. The first inclination angle of the upper sliding portion is larger than the second inclination angle of the lower sliding portion.

### Aspect 18

In Aspect 18,, in the sheet stacker according to any one of Aspects 13 to 17, the first-end side portion is rotatable about an upper end of the first-end side portion. The first-end side portion is biased to a receiving position to receive the sheet ejected from the ejection portion. The first-end side portion at the receiving position is inclined with respect to the vertical plane.

### Aspect 19

In Aspect 19, in the sheet stacker according to any one of Aspects 13 to 18, the sliding face has an opening.

### Aspect 20

In Aspect 20, in the sheet stacker according to any one of Aspects 13 to 18, the sliding face has a groove.

### Aspect 21

In Aspect 21, in the sheet stacker according to any one of Aspects 13 to 18, the sliding face includes multiple rods, each of which is extending downward, and arranged at intervals in the sheet ejection direction.

### Aspect 22

In Aspect 22, in the sheet stacker according to any one of Aspects 13 to 21, the bottom face is inclined downward from the first end toward the second end in the width direction.

### Aspect 23

In Aspect 23, the sheet stacker according to any one of Aspects 13 to 22 further includes a moving mechanism to move the sliding face, in the width direction, relative to the sheet ejected from the ejection portion, according to at least one of a type of the sheet or a size of the sheet in the width direction.

### Aspect 24

In Aspect 24, the sheet stacker according to any one of Aspects 13 to 22 further includes a rotation mechanism to rotate the sliding face about an upper end of the sliding face, according to at least one of a type of the sheet or a size of the sheet in the width direction.

### Aspect 25

In Aspect 25, the sheet stacker according to any one of Aspects 13 to 24 further includes circuitry to determine whether to eject the sheet from the ejection portion based on information of the sheet to be conveyed to the sheet stacker and information of the post-processing performed on the sheet, and control the ejection portion not to eject the sheet from the ejection portion in response to a determination that the sheet is not to be ejected from the ejection portion.

### Aspect 26

In Aspect 26, an image forming system includes the sheet stacker according to any one of Aspects 13 to 24, an image forming apparatus that forms an image on a sheet, and a post-processing apparatus to perform a folding operation on the sheet with the image formed by the image forming apparatus and convey the sheet to the sheet stacker.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet stacker comprising:
a bottom face on which a sheet,
subjected to a folding operation; and
ejected from an ejection portion in a sheet ejection direction,
is stacked;
a first-end side portion having a sliding face raised upward from the bottom face at a first end of the bottom face in a width direction orthogonal to the sheet ejection direction; and
a second-end side portion raised upward from the bottom face at a second end opposite to the first end in the width direction,
wherein the sliding face of the first-end side portion is inclined or curved with respect to a vertical plane.

2. The sheet stacker according to claim 1,
wherein the second-end side portion is raised vertically upward from the bottom face at the second end,
the sliding face of the first-end side portion is inclined or curved with respect to a vertical face of the second-end side portion,
the first-end side portion approaches the second-end side portion in the width direction toward the bottom face.

3. The sheet stacker according to claim 1,
wherein the sliding face of the first-end side portion has an upper end,
the ejection portion ejects the sheet having a maximum size, one side edge of which closer to the first end is at an ejection position at the ejection portion during an ejection of the sheet from the ejection portion, and
the ejection position is farther from the second end by a first distance in the width direction, and
the upper end is farther from the first end by a second distance larger than the first distance in the width direction.

4. The sheet stacker according to claim 1,
wherein the sliding face has an inclination angle with respect to the vertical plane,
the inclination angle decreases toward the bottom face.

5. The sheet stacker according to claim 4,
wherein the sliding face has:
an upper sliding portion having a first inclination angle with respect to the vertical plane; and
a lower sliding portion having a second inclination angle with respect to the vertical plane, and
the first inclination angle of the upper sliding portion is larger than the second inclination angle of the lower sliding portion.

6. The sheet stacker according to claim 1,
wherein the first-end side portion is rotatable about an upper end of the first-end side portion,
the first-end side portion is biased to a receiving position to receive the sheet ejected from the ejection portion, and
the first-end side portion at the receiving position is inclined with respect to the vertical plane.

7. The sheet stacker according to claim 1,
wherein the sliding face has an opening.

8. The sheet stacker according to claim 1,
wherein the sliding face has a groove.

9. The sheet stacker according to claim 1,
wherein the sliding face includes multiple rods, each of which is:
extending downward; and
arranged at intervals in the sheet ejection direction.

10. The sheet stacker according to claim 1,
wherein the bottom face is inclined downward from the first end toward the second end in the width direction.

11. The sheet stacker according to claim 1, further comprising:
a moving mechanism to move the sliding face, in the width direction, relative to the sheet ejected from the ejection portion,
according to at least one of:
a type of the sheet; or
a size of the sheet in the width direction.

12. The sheet stacker according to claim 1, further comprising:
a rotation mechanism to rotate the sliding face about an upper end of the sliding face,
according to at least one of:
a type of the sheet; or
a size of the sheet in the width direction.

13. The sheet stacker according to claim 1, further comprising:
circuitry configured to:
determine whether to eject the sheet from the ejection portion based on:
information of the sheet to be conveyed to the sheet stacker; and
information of a post-processing operation performed on the sheet; and
control the ejection portion not to eject the sheet from the ejection portion in response to a determination that the sheet is not to be ejected from the ejection portion.

14. An image forming system comprising:
the sheet stacker according to claim 1;
an image forming apparatus disposed upstream from the sheet stacker in a sheet conveyance direction, to form an image on a sheet; and
a post-processing apparatus to:
perform the folding operation on the sheet with the image formed by the image forming apparatus; and
convey the sheet subjected to the folding operation to the sheet stacker.
